(19) United States
(12) Patent Application Publication
(10) Pub. No.: US 2007/0230176 A1
(43) Pub. Date: Oct. 4, 2007

(54) System for maintaining location of utility housings during construction of a building and method of use

(76) Inventor: Lance Blazick, Ashley, PA (US)

Correspondence Address: Galasso & Associates, LP, P.O. Box 26503, Austin, TX, 78755-0503, US

(21) Appl. No.: 11/397,438

(22) Filed: Apr. 4, 2006

(51) Int. Cl. F21V 33/00

(52) U.S. Cl. 362/253

(57) ABSTRACT

A system for maintaining location of utility housings during construction of a building and method of use are provided. In one form, a method of locating housings within a structure of building during installation of a material to cover the housings comprises the steps of locating a housing prior to covering the housing and aligning an illumination fixture with the housing. The method further includes activating a light source of the illumination fixture to illuminate the housing and provide an illumination site prior to covering the housing using a material. A cavity may then be formed in the material to expose a portion of the housing using the illumination site.

### FIELD OF THE DISCLOSURE

The present invention generally relates to building construction, and more particularly, to a system for maintaining location of utility housings during construction of a building and method of use.

### BACKGROUND

Contractors typically have to account for a percentage of waste for every building constructed which adds to the overall cost of a building. One problem that contributes to an increase in the amount of waste may be attributed to errors in measuring various types of cuts or locations for holes to access utility housings within walls. For example, as a building is constructed, a wall without wall covering will typically include several installed electrical outlets, wall switches, telecommunication ports, cable or satellite connectors, or various other types of utility housings that provide access to utilities that are distributed within the structure or framework of a building. After such utilities, lines, etc. are installed throughout the building, wall covering is typically installed to the wall studs, ceiling joists, or other various types of framework to cover the housings.

For example, a building owner may desire to have drywall, sheetrock, paneling, or various other types of wall coverings placed over the framework of a building. As an installer installs such coverings, a location for each utility housing, etc. must be measured prior to covering each utility housing. A hole or cavity is typically provided at each location either before or after the covering is installed. However, from time to time, an installer may miss-measure the location of the housing and create a hole in a wrong location of the material. When such errors occur, an installer may have to repair the hole or replace the entire sheet of material if the hole cannot be repaired leading to increased labor and materials for installing wall and ceiling coverings. As such, what is needed is an inexpensive system for determining locations for housings to reduce wasted labor and materials during construction of a building.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for locating a housing within a building structure according to one aspect of the present invention;

FIG. 2 illustrates an expanded view of an illumination source mount for use with a system for locating a housing within a building structure according to one aspect of the invention; and

FIG. 3 illustrates a light source for use with a system for locating a housing within a building structure according to one aspect of the invention.

### DETAILED DESCRIPTION

A system for maintaining location of utility housings during construction of a building and method of use are disclosed. According to one aspect, a system for locating housings within a structure of building during installation of a material to cover the housings is provided. The system includes a pedestal securely coupled to a telescopic vertical member. The system further includes a light source coupled to the telescopic vertical member via a rotateable illuminator source mount operable to be rotated to locate a housing coupled to the structure of the building. The light source is operable to be illuminated to provide an illumination site during installation of the material.

According to another aspect of the invention, a method of locating housings within a structure of building during installation of a material to cover the housings is provided. The method includes the steps of locating a housing prior to covering the housing and aligning an illumination fixture with the housing. The method further includes activating a light source of the illumination fixture to illuminate the housing and provide an illumination site and covering the housing using a material.

According to a further aspect of the invention, an alignment system for locating housings within a structure of building during installation of a material to cover the housings to locate a housing prior to covering the housing. The system includes a pedestal securely coupled to a telescopic vertical member and a light source coupled to the telescopic vertical member via a rotateable illuminator source mount operable to be rotated to locate a housing coupled to the structure of the building. The light source is operable to be illuminated to provide an illumination site during installation of the material. The system further includes a rotateable mount coupled to a bottom portion of the rotateable illuminator source mount and operable to be rotated to align with the housing.

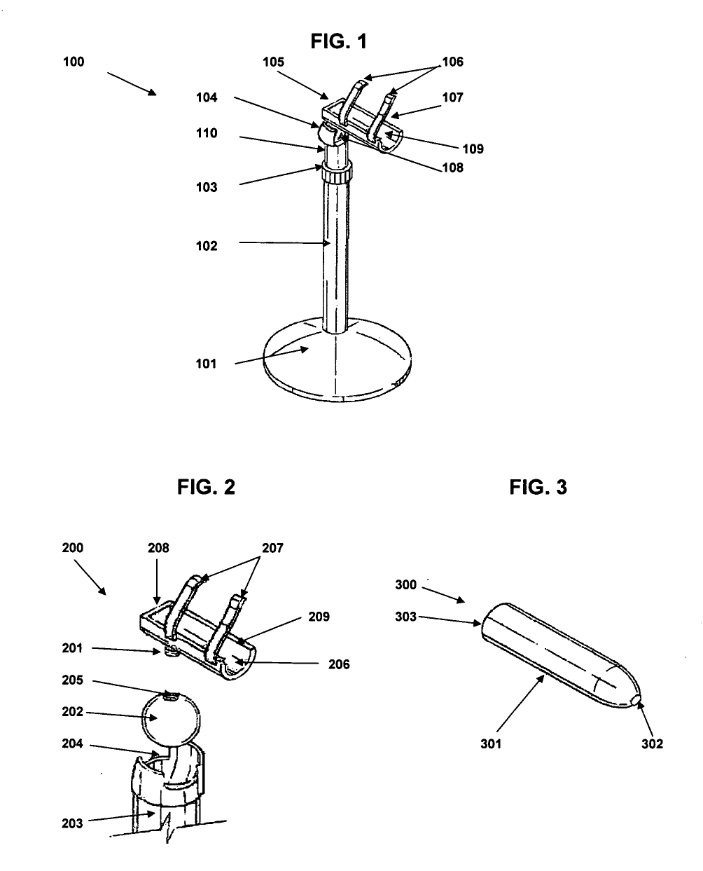

FIG. 1 illustrates a system for locating a housing within a building structure according to one aspect of the present invention. An alignment system, illustrated generally at 100, includes a cylindrical base 101 coupled to a vertical member 102 including a telescopic member 110 and an adjustable lock 103 operable to fix telescopic member 110 along a vertical axis to vary the overall height of alignment system 100. An illuminator mount 107 is coupled to telescopic member 110 using a ball 108 and socket 104 operable to vary the overall angle and direction of a light source (not expressly shown) mounted within illuminator mount 107. Alignment system 100 further includes coupling straps 106 for securely coupling a light source (not expressly shown) within illuminator mount 107. For example, a light source such as a laser may be placed within cavity 109 of illuminator mount 107 and pressed or butted up against end portion 105 of illuminator mount 107. A user may then use security straps 106 to fix a laser source in place.

Illuminator mount 107 may be formed from various types of materials including, but not limited to, plastics, metals, alloys, aluminum, rubber, PVC, or various combinations of materials. For example, laser mount 107 may be formed from aluminum and may include a rubber material coupled to cavity 109 to provide protection of a light source when installed. Other combinations of materials may also be employed as needed.

In one embodiment, pedestal 101 may be a weighted pedestal that allows for firmly placing alignment system at a specific location. For example, pedestal 101 may be formed from iron, lead or other heavy material to ensure that alignment system 100 is firmly located. Other embodiments may also be employed for securing alignment system 100. For example, one or more suction cups or cupped rubber material may be used to couple alignment system 100 to a specific location. If alignment system is used outdoors, one or more stakes may be placed around pedestal 101 or through an aperture of pedestal 101 (not expressly shown) to secure alignment system 100 to the ground at specific location.

During use, a user sets alignment system 100 on the ground or floor of a building under construction and adjusts the angle ball 108 and socket 104 and directs a light source placed within illuminator mount 109 towards a utility housing, such as an electrical outlet, communications port, electrical or lighting controller or switch, a recessed light assembly, a light fixture or mount, or any other type of utility housing or fixture that may be mounted within an interior of a wall. For example, a building may include an electrical outlet positioned along a portion of an interior of a wall at a specific height and location. A worker may desire to cover the wall with some type of wall cover material such as sheetrock, drywall, hardy plank, paneling, plywood or pressboard, or any other type of material that may be used as wall or ceiling covering. A user may direct the light source until it shines on the electrical outlet and ball 108 and socket 104 may be rotated until the light source illuminates the electrical outlet. A user may then obtain a piece of wall covering and position the wall covering to cover the electrical outlet. The light source shines directly at the location where the electrical box is located within the wall and illuminates the newly installed material at the location where the electrical outlet is installed within the framework of the wall. A user may then couple the wall covering to the wall using various types of coupling mechanisms such as nails, screws, etc. Upon coupling the wall covering, a user may then cut a hole in the wall covering at or close to the location where the light source is illuminating the wall. In this manner, a user need not cut a whole in the wall covering prior to coupling the wall covering to the wall thereby eliminating measurement errors that may occur when precutting wall materials or cutting after installation.

In one embodiment, a wall may include more than one utility housing. For example, a wall may include an outlet for a communications outlet, such as a data port, phone line, and the like. A wall may further include a separate housing for an electrical outlet. A user may then utilize two separate alignment systems 100 to provide a reference for each housing and align a light source at each housing prior to covering each housing. In this manner, a user may cover multiple housings using a single piece of material.

In one form, alignment system 100 may be configured to mount two separate light sources that may operate independent of each other (not expressly shown). A user may then align each light source at separate housings and cover the housings using the same piece of material.

In one embodiment, pedestal 101 may be formed from a heavy material or may be weighted to keep alignment system 100 from moving. In this manner, as a user aligns a light source with a housing, alignment system 100 may not be accidentally bumped or moved. In another embodiment, pedestal 101 may include coupling mechanisms to allow for coupling alignment system 100 to a floor so that the system may not move if accidentally bumped. Such coupling mechanisms may include one or more rubber suction cups, one or more mounting holes for nailing, screwing, staking, etc. pedestal to a floor, the ground, etc. In this manner, a user may not accidentally bump alignment system 100 causing an alignment error with housing located within a wall.

Illuminator mount 107 includes an ball 108 and socket 104 mount that may be angled from approximately zero (0) degrees to approximately ninety (90) degrees. For example, a user may use alignment system 100 to cover an electrical box or housing within a ceiling. Electrical boxes or housings within ceilings typically provide power for light fixtures, ceiling fans, surround sound wiring, and the like. As such, a user may direct a light source within illuminator mount 107 at an electrical box or housing mounted in the ceiling by rotating the illuminator mount 107 upward until the light source is incident on the outlet within the ceiling. A user may then cover the ceiling with a wall covering and cut a whole at the illumination site or location of the light source after covering the ceiling to expose the electrical box. As such, illuminator mount 107 may be provided at various angles to provide an illumination site to illuminate a housing as needed.

FIG. 2 illustrates an expanded view of a rotateable illumination source mount for use with a system for locating a housing within a building structure according to one aspect of the invention. A rotateable illuminator source mount, illustrated generally at 200, includes an illuminator source mount 206 having a cavity 209 for holding a light source such as a laser or other type of focused light source. Illuminator source mount 206 further includes mounting straps 207 that may be formed from a hook and loop material, clips, straps or other any other type of material that may be used to fix or hold a light source within cavity 209. Illuminator source mount 206 also includes an end portion 208 to securely fix light source at a specific location within cavity 209. Illuminator source mount 209 further includes a pivot mount 201 sized to securely mount within a mounting cavity 202 of sphere 205. In one embodiment, pivot mount 201 may be threaded to allow for rotating illumination source mount 206 when coupled to sphere 205. Sphere 205 is sized to securely fit within a socket 204 coupled to a telescopic rod 203 and socket 204 is sized secure sphere 205 while allowing various angles and positions to be maintained after rotating illuminator source mount 206 to a desired position. For example, sphere 205 may be rotated within socket 204 to a position and socket 204 may maintain the new position of sphere 205. In one form, socket 204 may be formed from an expandable or spring-like material that may allow for rotation of sphere 205 and illuminator source mount 206 while providing enough tension to sphere 205 to maintain a new position.

FIG. 3 illustrates a light source for use with a system for locating a housing within a building structure according to one aspect of the invention. A light source, illustrated generally at 300, includes a main body 301 having a generally cylindrical shape. Light source 300 includes and an end portion 302 operable to communicate a fine beam of light and an opposing rear portion 303 having a substantially flat surface. Light source 300 may include various types of light sources operable to transmit a fine or focused beam of light including, but not limited to, a laser light source, a halogen light source, a xenon light source or various other types of light sources. In one embodiment, light source 300 may include a low-power infra-red laser light source operable to shine or illuminate a red or amber colored laser light allowing for easy detection when illuminating materials such as wall coverings, sheetrock, paneling, or other types of material. Light source 300 is sized to fit within an illuminator mount such as illuminator source mount 107 or rotateable illuminator source 200 illustrated in FIGS. 1 and 2 respectively. For example, a user may mount light source 300 within illuminator source mount 107 and align light source 300 with a housing located within a building structure prior to covering a housing.

During use, with light source 300 mounted within illuminator mount 107, light source 300 may be illuminated to provide an illumination site located proximally or directly on a housing located within the framework of a wall. A worker may then cover the housing using a material and light source 300 having been aligned with the housing prior to covering the housing allows for identifying the exact location of the housing so that a cavity or hole may be cut into the material to expose the housing to access the housing. For example, sheet rock or drywall material may be placed over the housing and a user may form a hole in the drywall to expose a portion of the housing and install various other pieces of hardware or electrical components as needed.

In one embodiment, light source 300 mounted within illuminator mount 107, light source 300 may be illuminated to identify a housing located within the framework of a wall for a user to outline or trace the housing. For example, a illuminator mount 107 having light source 300 may be aligned with a specific point on an electrical housing and substantially centered to the housing to provide a reference point or location identifying the center of the housing. A substrate or wall covering may be placed over the reface point and a housing that is the same size as the housing mounted within the wall may be the reference point. A user may then outline the housing along the substrate using a pencil or other marking device to show the location and size of the housing located behind the substrate. In the manner, the substrate may be cut out along the outline allowing the user to accurately provide a hole in the substrate at the location of the housing. A similar process may be employed by light source 300 mounted within illuminator mount 107 to identify the location of plumbing fixtures, ceiling fixtures, etc.

In one embodiment, multiple illuminators may be used to locate four corners of a large area such as a window, door skylight, etc. For example, a user may locate an opening for a window by aligning four light sources 300 (not expressly shown) at each corner of a window, window frame, door frame, skylight frame, etc. A user may then move a substrate or panel in front the window and draw a line between each reference point provided by each light source 300 illuminating or identifying each corner. A user may then use using a marking utensil such as a chalk line, straight edge, etc. to draw a line between the reference points to identify the perimeter of the frame. In this manner, a user need only highlight the corners of a window or door to locate a window or door when covered with a wall covering.

In another embodiment, light source 300 mounted within illuminator mount 107, light source 300 may be illuminated to determine if a if a room is out of square. For example, if a room is out of square, a last panel or wall covering to be installed will need to be cut at what ever angle is needed to cover the remaining ‘out of square’ area. As such, two illuminator mounts 107 having light a light source 300 may be directed at an end portion and adjacent to location where the final panel is to be installed. For example, the two light source's 300 are aligned with one located along an upper portion of the opening and the second light source located along a lower portion of the opening. A user may then move the final panel into position with the edge butting against the wall and the illuminators illuminating the two locations. A user may then strike a chalk line from one illuminator mark to the other to provide a precise angle for cutting the final piece of wall covering. A user may then cut the wall covering at the desired angle and install accordingly.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A system for locating a housing within a structure of building during installation of a material to cover the housing, the system comprising:
a pedestal securely coupled to a telescopic vertical member; and
a light source coupled to the telescopic vertical member via a rotateable illuminator source mount operable to be rotated to locate a housing coupled to the structure of the building, the light source operable to be illuminated to provide an illumination site during installation of the material.

2. The system of claim 1, wherein the rotateable illuminator source mount comprises a ball and socket mount.

3. The system of claim 1, wherein the light source comprises a laser.

4. The system of claim 3, wherein the rotateable illuminator source mount comprises a cylinder having a cavity including an opening along a length and one end of the cylinder, the cavity operable to removeably couple the laser to the rotateable illuminator source mount.

5. The system of claim 4, wherein the rotateable illuminator source mount comprises a rotateable mount coupled to a bottom portion of the rotateable illuminator source mount.

6. The system of claim 5, wherein the rotateable mount comprises a ball and eye socket mount operable to fix the rotateable illuminator source mount to a position to align the light source with the housing.

7. The system of claim 1, wherein rotateable illuminator source mount includes at least one mounting strap operable to fix a removable light source to the rotateable illuminator source mount.

8. The system of claim 1, further comprising the rotateable illuminator source mount operable to align with a wall housing and further operable to be rotated to align with a ceiling housing.

9. The system of claim 1, further comprising:
coupling means for securing a light source to the rotateable illuminator source mount;
illumination means for providing an illumination site in association with the housing; and
alignment means for positioning the rotateable illuminator source mount to align the light source with the housing.

10. A method of locating a housing within a structure of building during installation of a material to cover the housing comprising the steps of:
locating a housing prior to covering the housing;
aligning an illumination fixture with the housing;
activating a light source of the illumination fixture to illuminate the housing and provide an illumination site; and
covering the housing using a material.

11. The method of claim 10, further comprising securing the material to a structure of a building.

12. The method of claim 11, further comprising providing a cavity in the material to expose a portion of the housing using the illumination site.

13. The method of claim 11 further comprising:
securing a pedestal of the illumination fixture; and
fixing the light source to maintain illumination at the illumination site.

14. The method of claim 11, further comprising:
locating a wall housing located within a wall of the structure;
aligning the illumination fixture with the wall housing;
illuminating the light source to provide the illumination site;
covering the wall housing with the material; and
providing a cavity within the material based on the illumination site.

15. The method of claim 14, further comprising:
locating a ceiling housing located within a ceiling of the building;
rotating a portion of the illumination fixture to align the light source with the ceiling housing;
illuminating the light source to provide the illumination site;
covering the ceiling housing with the material; and
providing a cavity within the material based on the illumination site.

16. The method of claim 14, further comprising:
locating a second wall housing located within the wall of the structure;
aligning a second illumination fixture with the second wall housing;
illuminating a second light source to provide a second illumination site;
covering the second wall housing with the material; and
providing a second cavity within the material based on the second illumination site.

17. An alignment system for locating housings within a structure of building during installation of a material to cover the housings to locate a housing prior to covering the housing, the system comprising:
a pedestal securely coupled to a telescopic vertical member; and
a light source coupled to the telescopic vertical member via a rotateable illuminator source mount operable to be rotated to locate a housing coupled to the structure of the building, the light source operable to be illuminated to provide an illumination site during installation of the material; and
a rotateable mount coupled to a bottom portion of the rotateable illuminator source mount and operable to be rotated to align the light source with the housing.

18. The system of claim 17 further comprising a ball and eye socket mount operable to fix the illumination source mount to a position to align the light source with the housing.

20. The system of claim 17 further comprising:
a second illumination fixture including a second rotateable illuminator source mount; and
a second light source coupled to the second rotateable illuminator source mount, the second light source operable to be aligned with a second housing to provide a second illumination site.
